(19) United States
(12) Patent Application Publication
(10) Pub. No.: US 2015/0286763 A1
(43) Pub. Date: Oct. 8, 2015

(54) PATTERN MATCHING FOR PREDICTING DEFECT LIMITED YIELD

(71) Applicant: GLOBALFOUNDRIES Inc., Grand Cayman (KY)

(72) Inventors: Lynn WANG, Fremont, CA (US); Sriram MADHAVAN, Santa Clara, CA (US); Vito DAI, Santa Clara, CA (US); Luigi CAPODIECI, Santa Cruz, CA (US)

(73) Assignee: GLOBALFOUNDRIES Inc., Grand Cayman (KY)

(21) Appl. No.: 14/243,551

(22) Filed: Apr. 2, 2014

(51) Int. Cl. G06F 17/50

(52) U.S. Cl. CPC G06F 17/5068

(57) ABSTRACT

Methods and apparatuses for pattern-based methodology for CAA and defect limited yield analysis are disclosed. Embodiments may include matching one or more patterns within a layer of an integrated circuit design layout to one or more pre-characterized patterns within a pattern library, determining respective critical areas of the one or more patterns based on respective pre-characterized critical areas of the one or more pre-characterized patterns, and predicting a defect limited yield of the layer based on the respective pre-characterized critical areas.

### TECHNICAL FIELD

The present disclosure relates to defect limited yield associated with integrated circuit design layouts. The present disclosure is particularly applicable to determining defect limited yield for 20 nanometer (nm) technology nodes and beyond.

### BACKGROUND

Defects in the manufacturing processes of integrated circuits can be categorized as two deformation types: shorts and opens. A short can be caused by unwanted material being present on a wafer surface, which causes two adjacent signal paths to electrically short. An open can be caused by material missing on the wafer surface, which causes a signal path to be electrically open.

Critical area analysis (CAA) measures the sensitivity of an integrated circuit design layout to measured inline defects. CAA is commonly used by semiconductor foundries to identify the sources of yield loss and to predict the random defect limited yield of the manufactured integrated circuits.

Conventional CAA tools used to perform CAA, however, have insufficiencies. For example, conventional CAA tools may take days to complete an analysis of an integrated circuit design layout. Further, the lack of localized guidance and prioritization for fixing layouts makes yield loss issues difficult to address. Global fixes are impractical solutions for preventing opens and shorts. For example, biasing all polygons to be bigger while maintaining design rule check compliance is often not possible without an area penalty. Also, measured defect density Dₒᵢ is assumed to be pattern independent in traditional CAA. This assumption is inaccurate because random and systematic yield issues may not be decoupled. For example, the Dₒᵢ for side-to-side spacing is different from tip-to-side spacing. Additionally, changes in a density distribution model used require the entire layout design to be re-simulated.

A need, therefore, exists for a pattern-based methodology to quickly and accurately identify the sources of yield loss and predict the random defect limited yield for an integrated circuit design layout, in addition to an apparatus capable of performing such a pattern-based methodology.

### SUMMARY

An aspect of the present disclosure is a pattern-based methodology that uses a library of pre-characterized patterns, each associated with a critical area, for CAA and defect limited yield analysis.

Another aspect of the present disclosure is an apparatus capable of performing a pattern-based methodology that uses a library of pre-characterized patterns, each associated with a critical area, for CAA and defect limited yield analysis.

Additional aspects and other features of the present disclosure will be set forth in the description which follows and in part will be apparent to those having ordinary skill in the art upon examination of the following or may be learned from the practice of the present disclosure. The advantages of the present disclosure may be realized and obtained as particularly pointed out in the appended claims.

According to the present disclosure, some technical effects may be achieved in part by a method including matching one or more patterns within a layer of an integrated circuit design layout to one or more pre-characterized patterns within a pattern library; determining respective critical areas of the one or more patterns based on respective pre-characterized critical areas of the one or more pre-characterized patterns; and predicting a defect limited yield of the layer based on the respective pre-characterized critical areas.

An aspect of the present disclosure includes determining numbers of repetitions of the one or more patterns in the layer, wherein the defect limited yield of the layer is based on a weighting of the respective pre-characterized critical areas based on the numbers of repetitions. A further aspect includes the respective pre-characterized critical areas including open-based critical areas and short-based critical areas. Still another aspect includes the respective pre-characterized critical areas including critical areas based on multiple random defect particle radii. Yet another aspect includes determining respective defect densities of the one or more patterns based on respective pre-characterized defect densities of the one or more pre-characterized patterns, wherein the defect limited yield of the layer is predicted based on the respective pre-characterized defect densities. A further aspect includes the respective pre-characterized defect densities including open-based defect densities and short-based defect densities based on multiple random defect particle radii. Yet another aspect includes the one or more patterns constituting a first area of the layer, determining a second area of the layer as a total area of the layer that excludes the one or more patterns; and determining a critical area of the second area based on conventional CAA, wherein the defect limited yield is predicted based on the respective pre-characterized critical areas and the critical area of the second area. Still another aspect includes the one or more pre-characterized patterns including an outer border area of empty space. Yet another aspect includes a width of the outer border area being based on a random defect particle radius to prevent a short based on a random defect particle interacting with a neighboring pattern.

Another aspect of the present disclosure is a device including at least one processor; and at least one memory including computer program code for one or more programs, the at least one memory and the computer program code configured to, with the at least one processor, cause the apparatus to perform the following: match one or more patterns within a layer of an integrated circuit design layout to one or more pre-characterized patterns within a pattern library; determine respective critical areas of the one or more patterns based on respective pre-characterized critical areas of the one or more pre-characterized patterns; and predict a defect limited yield of the layer based on the respective pre-characterized critical areas.

Aspects include the apparatus being further caused to determine numbers of repetitions of the one or more patterns in the layer, wherein the defect limited yield of the layer is based on a weighting of the respective pre-characterized critical areas based on the numbers of repetitions. Another aspect includes the respective pre-characterized critical areas including open-based critical areas and short-based critical areas. A further aspect includes the respective pre-characterized critical areas including critical areas based on multiple random defect particle radii. Another aspect includes the apparatus being further caused to determine respective defect densities of the one or more patterns based on respective pre-characterized defect densities of the one or more pre-characterized patterns, wherein the defect limited yield of the layer is predicted based on the respective pre-characterized defect densities. Yet another aspect includes the respective pre-characterized defect densities including open-based defect densities and short-based defect densities based on multiple random defect particle radii. Yet another aspect includes the one or more patterns constituting a first area of the layer, and the apparatus being further caused to determine a second area of the layer as a total area of the layer that excludes the one or more patterns; and determine a critical area of the second area based on conventional CAA, wherein the defect limited yield is predicted based on the respective pre-characterized critical areas and the critical area of the second area. Still another aspect includes the one or more pre-characterized patterns including an outer border area of empty space. A further aspect includes a width of the outer border area being based on a random defect particle radius to prevent a short based on a random defect particle interacting with a neighboring pattern.

Another aspect of the present disclosure is a method including building a pattern library of integrated circuit design layout library patterns pre-characterized based on critical area and defect density for multiple defect particle radii; scanning an integrated circuit design layout to determine one or more patterns within one or more layers that match one or more library patterns within the pattern library; determining respective critical areas and respective defect densities of the one or more patterns based on respective pre-characterized critical areas and respective pre-characterized defect densities of the matching one or more library patterns; and predicting respective defect limited yields of the one or more layers based on the respective pre-characterized critical areas and the respective defect densities. Still another aspect includes prioritizing correction of the one or more patterns based on the respective defect densities.

Additional aspects and technical effects of the present disclosure will become readily apparent to those skilled in the art from the following detailed description wherein embodiments of the present disclosure are described simply by way of illustration of the best mode contemplated to carry out the present disclosure. As will be realized, the present disclosure is capable of other and different embodiments, and its several details are capable of modifications in various obvious respects, all without departing from the present disclosure. Accordingly, the drawings and description are to be regarded as illustrative in nature, and not as restrictive.

### BRIEF DESCRIPTION OF THE DRAWINGS

The present disclosure is illustrated by way of example, and not by way of limitation, in the figures of the accompanying drawings and in which like reference numerals refer to similar elements and in which:

FIGS. 1A and 1B illustrate critical areas associated with different defect particle sizes, according to an exemplary embodiment;

FIGS. 2A through 2C illustrate pattern matching performed with pre-characterized patterns including a border, according to an exemplary embodiment;

FIGS. 3A through 3C illustrate alternative corrections to a problematic pattern, according to an exemplary embodiment;

FIG. 4 schematically illustrates an overall system for implementing pattern-based methodology for CAA and defect limited yield analysis, according to an exemplary embodiment;

FIG. 5A is a flowchart of a process for a pattern-based methodology for CAA and defect limited yield analysis, according to an exemplary embodiment;

FIG. 5B is a flowchart of a process for a hybrid based-methodology for CAA and defect limited yield analysis, according to an exemplary embodiment; and

FIG. 6 schematically illustrates a computer system for implementing the system of FIG. 4 and the processes of FIGS. 5A and 5B, according to an exemplary embodiment.

### DETAILED DESCRIPTION

In the following description, for the purposes of explanation, numerous specific details are set forth in order to provide a thorough understanding of exemplary embodiments. It should be apparent, however, that exemplary embodiments may be practiced without these specific details or with an equivalent arrangement. In other instances, well-known structures and devices are shown in block diagram form in order to avoid unnecessarily obscuring exemplary embodiments. In addition, unless otherwise indicated, all numbers expressing quantities, ratios, and numerical properties of ingredients, reaction conditions, and so forth used in the specification and claims are to be understood as being modified in all instances by the term “about.”

The present disclosure addresses and solves issues of inefficiency and run-time attendant upon CAA and defect limited yield analysis based on conventional approaches. In accordance with embodiments of the present disclosure, a pattern-based methodology is used to determine defect limited yield based on pre-characterized patterns and associated critical areas and defect densities.

Methodology in accordance with an embodiment of the present disclosure includes matching one or more patterns within a layer of an integrated circuit design layout to one or more pre-characterized patterns within a pattern library. Respective critical areas of the one or more patterns based on respective pre-characterized critical areas of the one or more pre-characterized patterns are then determined. A defect limited yield of the integrated circuit design layout layer is then predicted based on the respective pre-characterized critical areas.

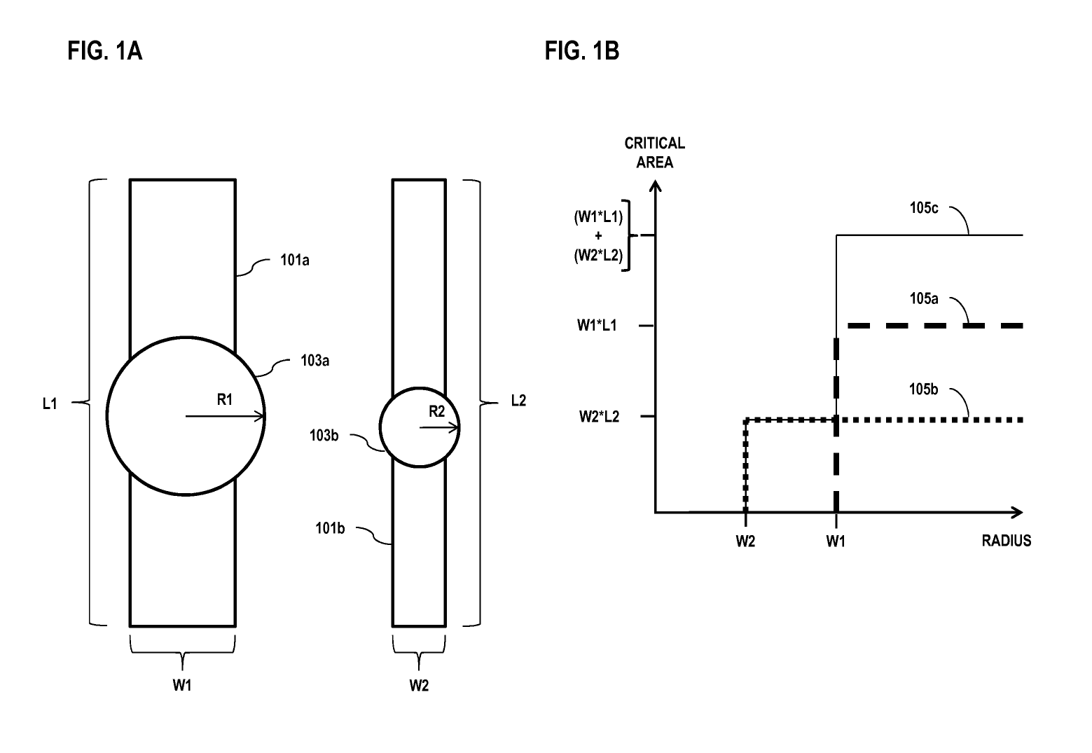

CAA can be modeled according to the layout area in which the center of the random defect particle, such as a particle with a radius r, must land to produce an open or short in the layout. Thus, critical area (CA) is a function of r, e.g., CA(r), and is computed by measuring the sensitivity of layout dimensions to a defect particle of radius r. FIGS. 1A and 1B demonstrate this property with metal line (e.g., M1) opens.

Adverting to FIG. 1A, metal lines 101a and 101b are illustrated. Metal line 101a may have a length L1 and a width W1. Metal line 101b may have a length L2 and a width W2. The critical area associated with metal line 101a remains 0 until the center of a random defect particle 103a with a radius R1 equal to W1 lands on the metal line 101a, causing an open. Thus, at a radius of R1 equal to W1, the critical area is the area of the metal line 101a, W1*L1, indicating that the entire metal line 101a contains an open. For a defect particle size with a radius R1 greater than W1, the critical area associated with the metal line 101a saturates at the area of the line because any defect particle size of a radius R1 greater than or equal to W1 would cause an open.

Similarly, the critical area associated with metal line 101b remains 0 until the center of a random defect particle 103b with a radius R2 equal to W2 lands on the metal line 101b, causing an open. Thus, at a radius of R2 equal to W2, the critical area is the area of the metal line 101b, W2*L2, indicating that the entire metal line 101b contains an open. For a defect particle size with a radius R2 greater than W2, the critical area associated with the metal line 101b saturates at the area of the line because any defect particle size of a radius R2 greater than or equal to W2 would cause an open.

Based on basic Euclidean geometry, which dictates that the total area is equal to the sum of its individual parts, the total critical area is simply the sum of the individual critical areas for each metal line. To demonstrate this axiom, the critical areas for the metal lines 101a and 101b are calculated individually, and the sum of the two is computed to determine the total critical area. FIG. 1B illustrates a plot of radius size of the random defect particle versus the critical area. Line 105a represents the critical area associated with the metal line 101a, which is zero until the radius is equal to or greater than W1. Line 105b represents the critical area associated with the metal line 101b, which is zero until the radius is equal to or greater than W2. Line 105c represents the total critical area associated with an integrated circuit design layout including metal lines 101a and 101b, which is based on the total of critical areas of metal lines 101a and 101b. The line 105c is zero until the radius is W2, at which point the total critical area is W2*L2. The line 105c remains at W2*L2 until the radius is W1, at which point the total critical area is (W2*L2)+(W1*L1), resulting from the combination of the critical areas for metal lines 101a and 101b.

Based on the foregoing, the total critical area of an integrated circuit design layout can be expressed as the sum of the individual parts of the layout.

Σᵣ₌ᵣ₁^{rm}CA(r)ᵢ=Σₚ₌ₚ₁^{pn}Σᵣ₌ᵣ₁^{rm}kₚCA(r)_{i,p} (1)

Equation 1 represents the total critical area for a layer i within an integrated circuit design layout as the sum of the critical areas for each individual part n as a function of the radius r, in which r can be discretized from 1 to m. Equation 1 can be generalized to layout patterns such that the critical area of a layout is the sum of the n unique patterns within the layout. Thus, each part of a layout can be represented by a layout pattern p₁ to pₙ, in which p₁ is the first pattern and pₙ is the n-th pattern. If a layout pattern repeats within the layout, the critical area represented by the repeated pattern can be weighted by the number of repetitions kₚ.

Each pattern is pre-characterized for its critical area per layer for opens and shorts and stored in a pattern library. The critical area associated with each pre-characterized pattern can be stored as a look-up table of discretized particle size radius r. Table 1 provides exemplary critical areas for two pre-characterized patterns, p₁ and p₂, at four different radii for open and short. However, the number of patterns, the number of radii and the specific value of the radii can vary.

TABLE 1

| Radius | 0.02 | 0.07 | 0.09 | 0.1 |
|---|---|---|---|---|
| p₁ - Open | 0.0018 | 0.047 | 3.01 | 3.07 |
| p₁ - Short | 0 | 0.011 | 2.76 | 3.07 |
| p₂ - Open | 0.0037 | 0.095 | 6.03 | 6.15 |
| p₂ - Short | 0 | 0.022 | 5.53 | 6.15 |

Once a pattern library and its look-up table are built, given any integrated circuit design layout, a pattern matching engine can be used to search for patterns from the pattern library. If matches are found, the total critical area is computed using the number of matches and the values from the look-up table. Based on the values provided in Table 1, and assuming 10 matches of p₁ and 20 matches of p₂ within an M1 layer, Equation 1 simplifies to Equation 2 for an M1 open critical area:

$${CA ( r )}_{M 1 , Open} = 10 [ \begin{matrix}{CA ( 0.02 )}_{M 1. Open , p 1} + {CA ( 0.07 )}_{M 1. Open , p 1} + \\ {CA ( 0.09 )}_{M 1. Open , p 1} + {CA ( 0.1 )}_{M 1. Open , p 1}\end{matrix} ] + 20 [ \begin{matrix}{CA ( 0.02 )}_{M 1. Open , p 2} + {CA ( 0.07 )}_{M 1. Open , p 2} + \\ {CA ( 0.09 )}_{M 1. Open , p 2} + {CA ( 0.1 )}_{M 1. Open , p 2}\end{matrix} ] \qquad ( 2 )$$

Further, the pre-characterized patterns and associated critical areas for each pattern may also be used to predict a defect limited yield for the integrated circuit design layout. First, an expected number of failures A, on a layer i can be computed as:

λᵢ=DₒᵢΣᵣ₌ᵣ₁^{r=rm}CAᵢ(r)fᵢ(r)Δr (3)

where CAᵢ(r) represents the critical area in layer i of an integrated circuit design layout for a defect particle size of radius r, Dₒᵢ is the measured defect density for the layer i, and the product CAᵢ(r)Dₒᵢ represents the number of defects of radius r on layer i that would result in a functional failure. Further, ƒᵢ(r) represents the density distribution function, and Δr is the step size. The density distribution function ƒᵢ(r) can be empirically modeled using the inverse power law. For certain mature technologies, the function can be modeled as 1/r³. Thus, the critical area of the pre-characterized patterns found in the pattern library can be substituted into Equation 3, and 1/r³, can be substituted for ƒᵢ(r) resulting in:

$${λ}_{i} = {D}_{oi} Δ r [ \frac{1}{{r}_{1}^{3}} {CA}_{i} ( {r}_{1} ) + \frac{1}{{r}_{2}^{3}} {CA}_{i} ( {r}_{2} ) + … + \frac{1}{{r}_{m}^{3}} {CA}_{i} ( {r}_{m} ) ] \qquad ( 4 )$$

Assuming that the failure event follows a Poisson model, the probability of failure Pᵣᵢ(k) is:

$${P}_{{r}_{i}} ( k ) = \frac{exp ( - {λ}_{i} ) {λ}_{i}^{k}}{k !} \qquad ( 5 )$$

where k denotes the number of failures. The yield is defined as the probability when no failure occurs, i.e., k=0. Thus, the yield loss can be estimated by:

Pᵣ_{ᵢ}(k=0)=exp(−λᵢ) (6)

Accordingly, Equation 6 can be used to estimate the yield on layer i based on critical area. Alternatively, other yield models, such as a negative binomial yield model, can be used for different probability distribution of failure event occurrences. Thus, other yield models can be applied to to estimate yield loss.

In addition to storing the critical area in the pattern library for the pre-characterized patterns, Dₒᵢ can also be stored for each pre-characterized pattern. Storing Dₒᵢ for each pre-characterized pattern can improve the accuracy of the yield modeling. Thus, Table 1 above can be modified to include pattern-specific Dₒᵢ for each radius for open and short for each pre-characterized pattern.

With each pre-characterized pattern including a Dₒᵢ for each specific radius of a defect particle and for open and short, Equation 4 can be simplified according to:

$${λ}_{i} = Δ r \{ \begin{matrix}\frac{1}{{r}_{1}^{3}} [ \begin{matrix}{D}_{oi , p 1} {CA}_{i , p 1} ( {r}_{1} ) + {D}_{oi , p 2} {CA}_{i , p 2} ( {r}_{1} ) + … + \\ {D}_{oi , pn} {CA}_{i , pn} ( {r}_{1} )\end{matrix} ] + … + \\ \frac{1}{{r}_{m}^{3}} [ \begin{matrix}{D}_{oi , p 1} {CA}_{i , p 1} ( {r}_{m} ) + {D}_{oi , p 2} {CA}_{i , p 2} ( {r}_{m} ) + … + \\ {D}_{oi , pn} {CA}_{i , pn} ( {r}_{m} )\end{matrix} ]\end{matrix} \} \qquad ( 7 )$$

Once λᵢ is obtained according to Equation 7, the yield models presented in Equations 5 and 6 can be applied accordingly.

Ideally, any integrated circuit design layout can be represented by a library of pre-characterized patterns given that the pattern library coverage is complete. However, if an integrated circuit design layout contains patterns that are not in the pattern library, a hybrid approach can be used to compute the critical area and predict the defect limited yield. According to a hybrid approach, run-time improvement provided by pre-characterized patterns and pattern matching is still preserved while still accounting for all of the critical area and accurately predicting the defect limited yield.

In the hybrid flow, given an integrated circuit design layout, pattern-based CAA is first used to determine the critical area according to the above equations. Afterwards, a layout manipulation script/engine excludes the patterns that have been matched by pattern matching to one or more pre-characterized patterns within the pattern library. Conventional CAA employing commercial tools may then be used to determine the critical area for the remaining integrated circuit design layout. The sum of the critical areas extracted by pattern matching and that extracted from conventional CAA can then be used to predict the defect limited yield.

The pattern library can be built from existing designs, silicon testing, and simulations. If a pattern is classified as unique (i.e., does not duplicate a pattern already in the pattern library), the pattern is stored in the pattern library. CAA may then be performed on the pattern according to conventional techniques to determine the critical area for multiple different radii for open and short. Thus, a pre-characterized pattern is determined for the pattern, as discussed above with respect to Table 1. A generic measured defect density Dₒᵢ also can be associated with the pattern. For patterns that have been identified as yield detractors based on previous simulations, modeling, or design manufactures, the associated Dₒᵢ can be further examined. To do so, test structures can be created for these patterns so that the patterns can be measured using in-line testing and scan diagnostics. The Dₒᵢ can alternatively, or in addition, be determined through lithography simulations. Since the lithography process variation bands (i.e., PV bands) represent the 3 sigma of the process variation, these problematic patterns are simulated with varying contexts, and the Dₒᵢ of opens and shorts can be determined and stored within the pattern library for each pre-characterized pattern. The stored Dₒᵢ can then be used as discussed above for a more accurate approach.

The pre-characterized patterns may be stored and/or constructed with a border of empty space to mitigate context issues. The dimension of the space may be large enough so that the probability of a defect particle size causing a short between the pre-characterized pattern and a neighboring pattern is small. Further, for the hybrid flow, when a pattern is matched to a pre-characterized pattern, the pattern is excluded from the layout. This border of empty space required by the pattern prevents the dividing of the polygons into two pieces for analysis, which would render the modeling of shorts inaccurate.

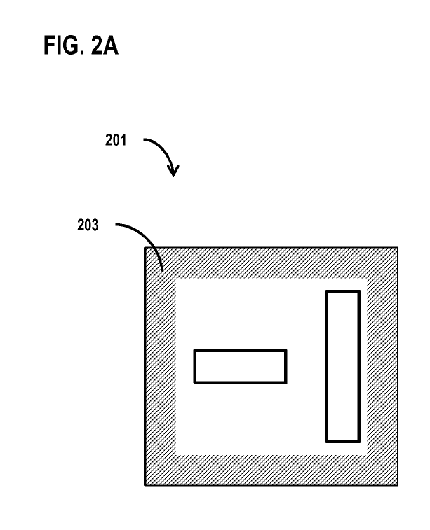

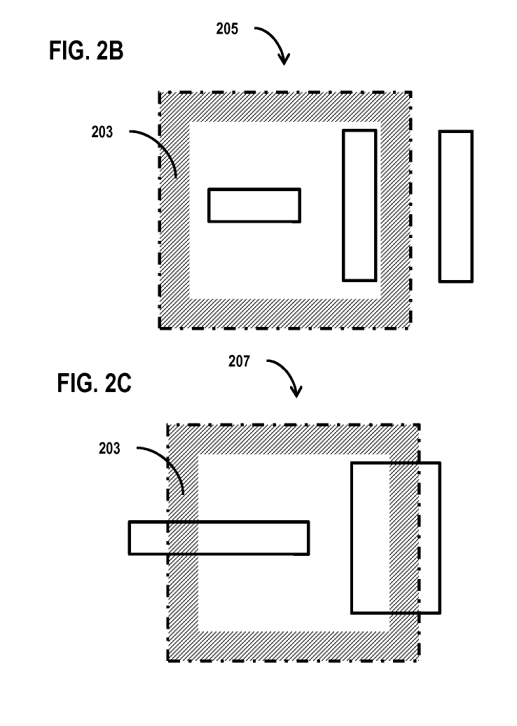

FIG. 2A illustrates a pre-characterized pattern 201 including a border 203. Due to the border 203 preserved around the pre-characterized pattern 201, the pre-characterized pattern 201 is matched to pattern 205, illustrated in FIG. 2B, but not to pattern 207, illustrated in FIG. 2C. Thus, the border 203 prevents the situation presented in FIG. 2C in which one or more polygons are split into multiple, smaller polygons, which would render the critical area analysis for shorts inaccurate.

In the course of pattern matching, patterns within the integrated circuit design layout matched to pre-characterized patterns within the pattern library may overlap with other patterns within the integrated circuit design layout. The overlap can lead to double-counting of the pre-characterized pattern and, thus, render the pattern-based CAA analysis inaccurate. Various approaches can be implemented to prevent any single part of an integrated circuit design layout from being matched multiple times, such as a marker layer where a pattern has matched a pre-characterized pattern. For any new matches, if the matched pattern overlaps with the marker layer, the pattern would be dropped.

In the traditional CAA flow, there exists no localized guidance for layout fixing. For example, metal wire opens are addressed by simply increasing all line widths. This approach is impossible without increasing the area of the design while maintaining design rule check compliance.

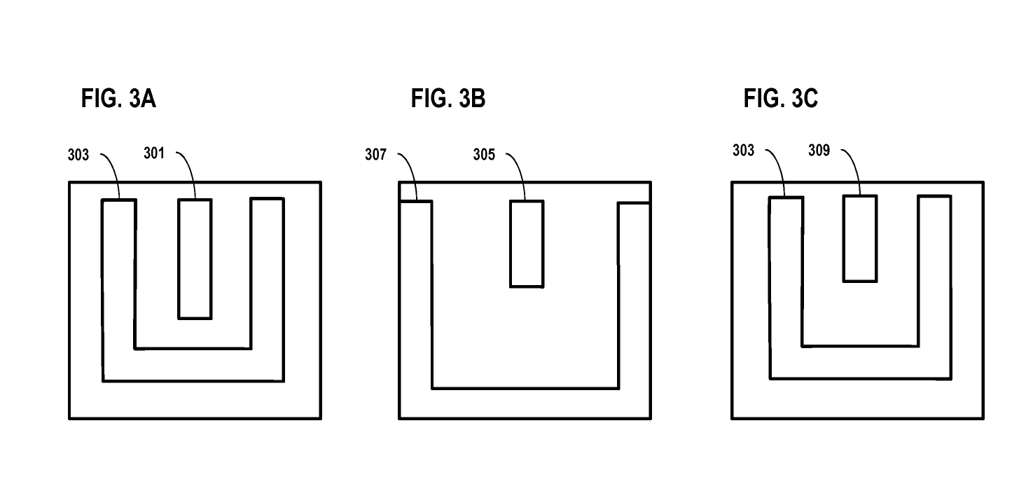

However, the pre-characterized patterns may be stored in the pattern library along with localized approaches to correct problematic locations. FIG. 3A presents a pattern that is problematic for M1 shorts. Namely, the bottom end of portion 301 is too close to the horizontal section of portion 303. The suggested fix, using traditional CAA, is illustrated in FIG. 3B. As shown, the lack of localized guidance in traditional CAA leads to the increasing of all spacing at the expense of area based on enlarging portion 303 into portion 307 and shrinking portion 301 into portion 305. However, the pattern-based approach identifies sources of yield loss and enables specific localized fixes such that changes to the drawn layout are optimized without increasing its area. Specifically, as illustrated in FIG. 3C, portion 303 is maintained, but portion 301 is replaced with portion 309, and the length of portion 309 is reduced to increase the distance from portion 309 to the horizontal section of portion 303.

Further, pre-characterization of yield-detracting patterns enables the prioritization of problematic patterns by criticality. Patterns can be ranked by the severity of measured defect densities Dₒᵢ. This ranking can be used to address the order that the patterns need to be fixed under schedule constraints.

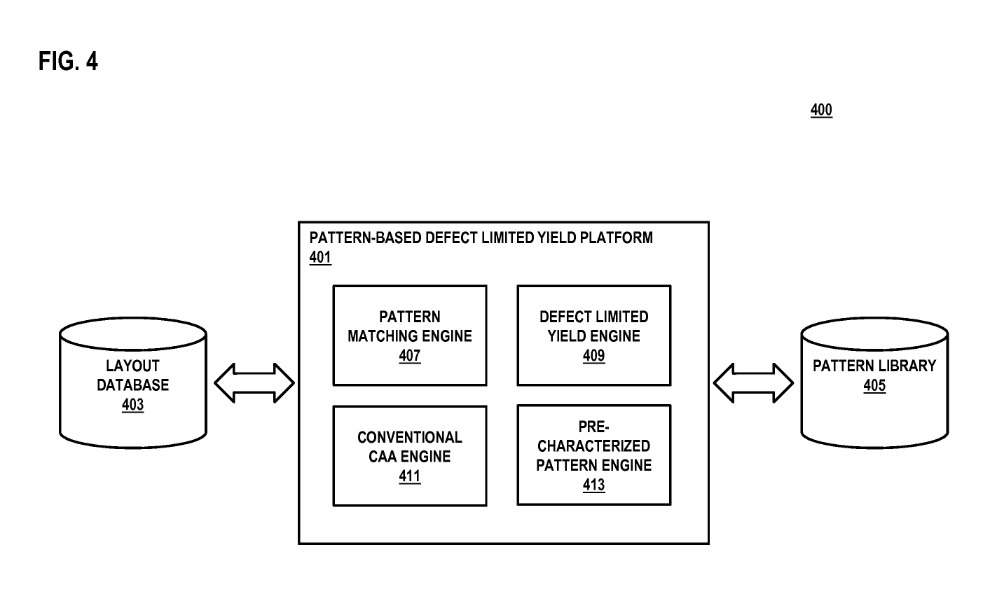

FIG. 4 schematically illustrates an overall system 400 for implementing pattern-based methodology for CAA and defect limited yield analysis, according to an exemplary embodiment. The system 400 includes a pattern-based defect limited yield platform 401. The platform 401 performs the functionality described herein associated with implementing pattern-based methodology for CAA and defect limited yield analysis. The platform 401 may be in communication with a layout database 403. The layout database 403 may include one or more integrated circuit design layouts on which the platform 401 performs pattern-based methodology for CAA and defect limited yield analysis. However, the one or more design layouts may be stored, sent to, and/or received by the platform 401 according to various different techniques and/or methods. Upon processing the design layouts, the platform 401 may store the processed information at the layout database 403, or at one or more other databases, at the designer of the design layout, or other locations (not shown for illustrative convenience). Thus, how and from where the design layouts are obtained and where the processed information is sent or used can vary without varying from the scope of the present disclosure.

The system 400 also includes a pattern library 405. The pattern library 405 stores one or more pre-characterized patterns that are used for matching to one or more patterns within an analyzed design layout. The pattern library 405 stores, associated with the pre-characterized patterns, information regarding critical area of the pre-characterized patterns for multiple different defect particle radii, as well as for open and short defects. The number and specific values of the different radii can vary according to the technology of the design layouts or other factors and is not limited to a set number of radii. Likewise, the pattern library 405 can hold numerous different pre-characterized patterns. The pattern library 405 may also include Dₒᵢ for the pre-characterized patterns. Like the critical area, the pattern library may store the Dₒᵢ at multiple different radii for opens and shorts. The pre-characterized patterns within the pattern library 405 may be relatively small compared to the overall size of an integrated circuit design layout, such as 100 nm by 100 nm. The size of the pre-characterized patterns allows for determining small, discrete patterns within an integrated circuit design layout that match the pre-characterized patterns that are prone to random-defect-induced opens and/or shorts. Once determined, such patterns can be localized, prioritized, and strategically fixed to improve the defect limited yield of the integrated circuit design layout.

The platform 401 may include various engines that perform various specific functionality discussed above. As illustrated, the platform 401 may include a pattern matching engine 407. The pattern matching engine 407 may perform the functionality of analyzing an integrated circuit design layout for one or more patterns that match one or more of the patterns within the pattern library 405. The matching may be based on various pattern matching technologies.

The platform 401 may also include a defect limited yield engine 409. Based on the pre-characterized patterns that match patterns within a design layout, the defect limited yield engine 409 may extract the critical area, or the critical area and Dₒᵢ, of the pre-characterized patterns from the pattern library. Upon obtaining the critical area, the defect limited yield engine performs the above-discussed analysis for determining the CAA and/or predicting the defect limited yield of the analyzed design layout. Where all patterns within a design layout match one or more pre-characterized patterns within the pattern library, the defect limited yield engine 409 performs all of the analysis for determining the CAA and/or predicting the defect limited yield. Further, the defect limited yield engine 409 may also perform functionality associated with replacing patterns within the design layout that are associated with a high Dₒᵢ and/or a high critical area with replacement patterns as discussed above.

The platform 401 may also include a conventional CAA engine 411 that can perform conventional analysis with respect to determining critical area and/or predicting defect limited yield for the design layout. As discussed above, in cases where patterns in a design layout are not matched entirely to one or more pre-characterized patterns within the pattern library 405, pattern-based CAA performed by the defect limited yield engine 409 and conventional CAA performed by the conventional CAA engine 411 may be combined for determining the critical area of a design layout and/or for predicting the defect limited yield of a design layout. Alternatively, the conventional CAA engine 411 may be excluded from the platform 401 and conventional CAA may be performed by one or more third party tools for conventionally determining critical area (not show for illustrative convenience).

The platform 401 may further include a pre-characterized pattern engine 413. The pre-characterized pattern engine 413 may build and/or add to the pattern library 405 by building pre-characterized patterns as discussed above. The pre-characterized pattern engine 413 may store information regarding unique patterns that are not already in the pattern library 405 as those unique patterns are encountered by the platform 401 in processing patterns within a design layout. The pre-characterized pattern engine 413 may determine the critical area and/or the Dₒᵢ of the patterns according to the techniques discussed above.

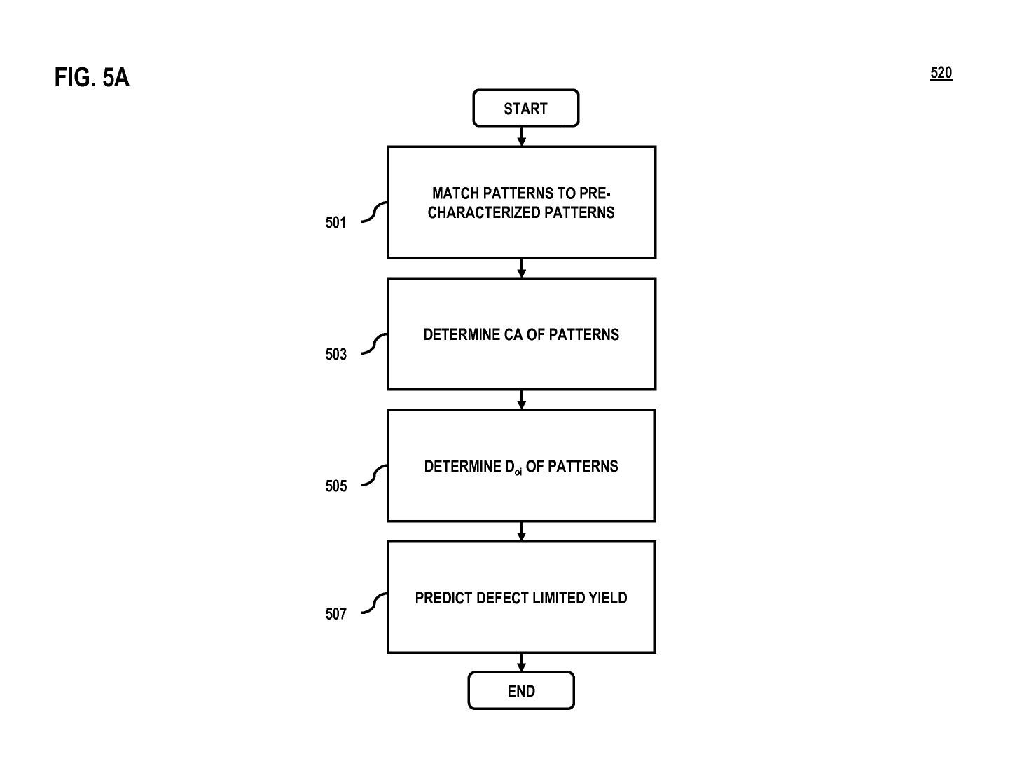

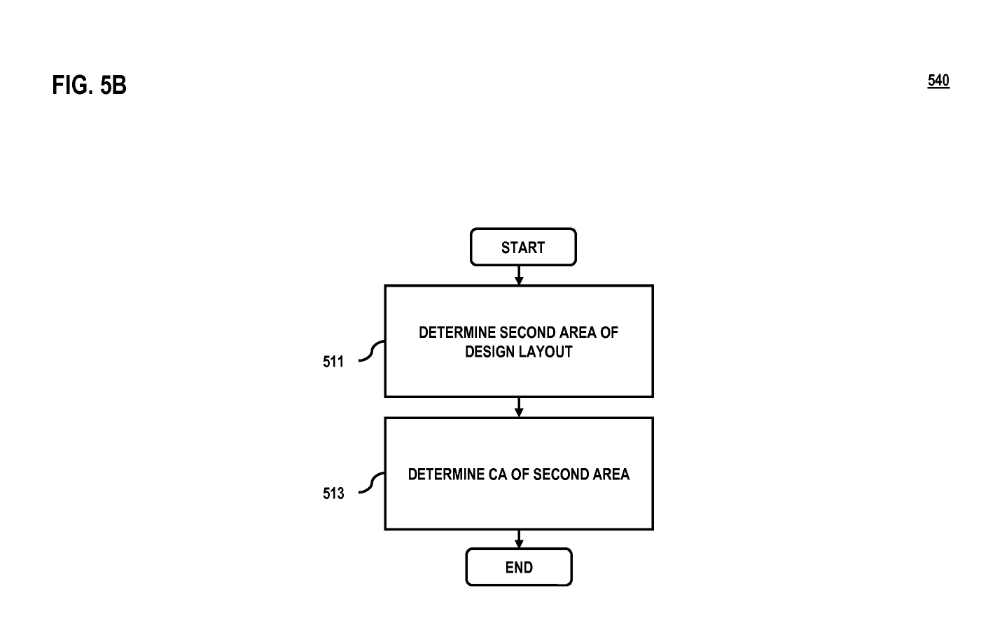

FIG. 5A is a flowchart of a process 520 of a pattern-based methodology for CAA and defect limited yield analysis, according to an exemplary embodiment. At step 501, one or more patterns within a layer of an integrated circuit design layout are matched to one or more pre-characterized patterns within a pattern library. The matching may occur according to any type of pattern matching functionality. During matching, various approaches can be implemented to prevent any single part of an integrated circuit design layout from being matched multiple times to pre-characterized patterns. Patterns within the integrated circuit design layout that match pre-characterized patterns within the pattern library may be marked, such as by using a marker layer, to prevent multiple matches affecting the analysis. Further, such a marker layer may be used to determine which parts of a design layout have matched to pre-characterized patterns for later analysis of non-matching areas, as discussed in more detail with respect to FIG. 5B.

In matching the patterns within the design layout to pre-characterized patterns within the pattern library 405, repetitions of repeated patterns within the design layout that do not overlap other matched patterns may be determined. The number of repetitions for patterns may then be used for each pattern rather than treating each repetition of a pattern separately.

At step 503, respective critical areas of the one or more patterns are determined based on respective pre-characterized critical areas of the one or more pre-characterized patterns. The critical areas may be determined using lookup tables within the pattern library 405. Further, single respective critical areas may be determined for each matched pattern for a single defect particle radius. Alternatively, multiple respective critical areas may be determined for each matched pattern for multiple defect particle radii. The respective pre-characterized critical areas include open-based critical areas and short-based critical areas, thus accounting for open-based critical areas and short-based critical areas within the design layout.

Although optional, at step 505, respective defect densities of the one or more patterns may be determined based on respective pre-characterized defect densities of the one or more pre-characterized patterns. The defect densities may be determined using look-up tables within the pattern library 405. Further, a single respective defect density may be determined for each matched pattern for a single defect particle radius. Alternatively, multiple respective defect densities may be determined for each matched pattern for multiple defect particle radii. The respective pre-characterized defect densities include open-based defect densities and short-based defect densities based on multiple random defect particle radii, thus accounting for open-based defect densities and short-based defect densities within the design layout.

At step 507, the defect limited yield of the layer is predicted based on the respective pre-characterized critical areas according to the methods discussed above. That is, using the critical areas from the matched patterns, the yield loss can be determined using Equations 4 through 6 discussed above. Where the respective defect densities are determined for the matched patterns, the defect limited yield of the layer can be predicted based on the respective pre-characterized defect densities.

Specifically, the defect limited yield can be predicted according to Equation 7 discussed above. Based on the above methodology, defect limited yield for a layer of an integrated circuit design layout can be determined with less complexity than based on conventional methodology for determining critical area.

FIG. 5B is a flowchart of a process 540 for a hybrid based-methodology for CAA and defect limited yield analysis, according to an exemplary embodiment. Prior to step 511, after patterns within the design layout are matched to pre-characterized patterns, the area represented by the matched patterns may represent a first area. At step 511, a second area of the layer is determined that excludes the one or more patterns matching pre-characterized patterns. The second area is, thus, a total area of the design layout excluded from the first area.

At step 513, a critical area of the second area is determined. Because there are no patterns within the second area that match pre-characterized patterns within the pattern library, the critical area of the second area is determined based on conventional CAA tools. The sum of the critical area extracted by pattern matching within the first area and that extracted from conventional CAA within second area can then be used to predict the defect limited yield based on combining the two critical areas.

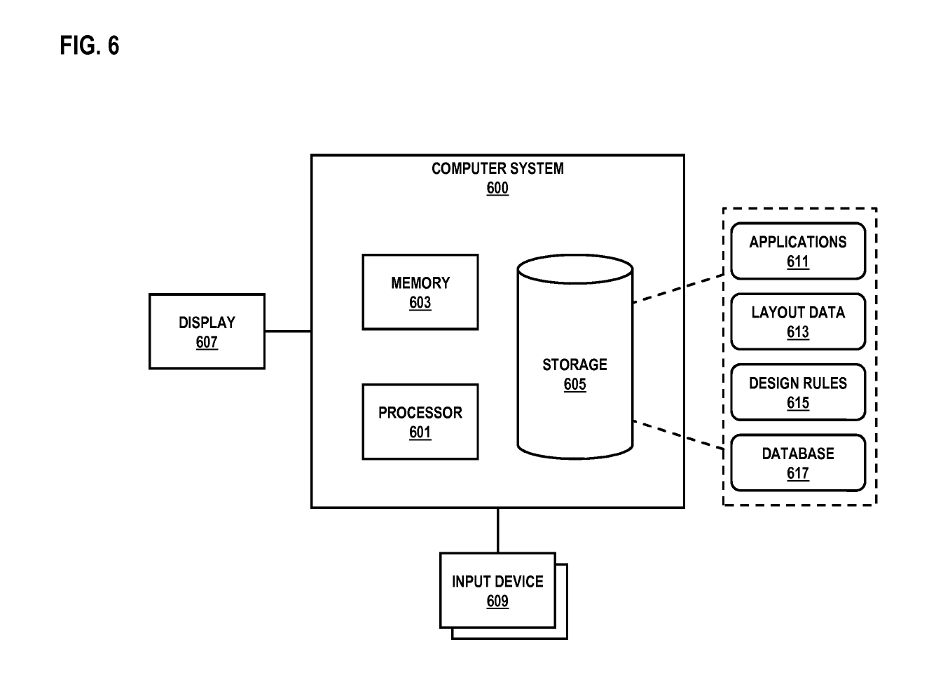

The processes described herein may be implemented via software, hardware, firmware, or a combination thereof. Exemplary hardware (e.g., computing hardware) is schematically illustrated in FIG. 6. As shown, computer system 600 includes at least one processor 601, at least one memory 603, and at least one storage 605. Computer system 600 may be coupled to display 607 and one or more input devices 609, such as a keyboard and a pointing device. Display 607 may be utilized to provide one or more GUI interfaces. Input devices 609 may be utilized by users of computer system 600 to interact with, for instance, the GUI interfaces. Storage 605 may store applications 611, layout data (or information) 613, design plus rules 615, and at least one pattern database (or repository) 617. Applications 611 may include instructions (or computer program code) that when executed by processor 601 cause computer system 600 to perform one or more processes, such as one or more of the processes described herein. In exemplary embodiments, applications 611 may include one or more conventional CAA tools.

The embodiments of the present disclosure achieve several technical effects, including improving run-time for CAA and defect limited yield predictions, mitigating defect-induced opens and shorts by localized corrections, including prioritizing problematic patterns, specifying specific Dₒᵢ for specific patterns to improve the overall accuracy of the CAA and yield predictions, and changing the density distribution model without the re-simulation of the design based on the separation of layout design and density distribution model. The present disclosure enjoys industrial applicability associated with the designing and manufacturing of any of various types of highly integrated semiconductor devices used in microprocessors, smart phones, mobile phones, cellular handsets, set-top boxes, DVD recorders and players, automotive navigation, printers and peripherals, networking and telecom equipment, gaming systems, and digital cameras, particularly for 20 nm technology nodes and beyond.

In the preceding description, the present disclosure is described with reference to specifically exemplary embodiments thereof. It will, however, be evident that various modifications and changes may be made thereto without departing from the broader spirit and scope of the present disclosure, as set forth in the claims. The specification and drawings are, accordingly, to be regarded as illustrative and not as restrictive. It is understood that the present disclosure is capable of using various other combinations and embodiments and is capable of any changes or modifications within the scope of the inventive concept as expressed herein.

What is claimed is:

1. A method comprising:
matching one or more patterns within a layer of an integrated circuit design layout to one or more pre-characterized patterns within a pattern library;
determining respective critical areas of the one or more patterns based on respective pre-characterized critical areas of the one or more pre-characterized patterns; and
predicting a defect limited yield of the layer based on the respective pre-characterized critical areas.

2. The method according to claim 1, further comprising:
determining numbers of repetitions of the one or more patterns in the layer,
wherein the defect limited yield of the layer is based on a weighting of the respective pre-characterized critical areas based on the numbers of repetitions.

3. The method according to claim 1, wherein the respective pre-characterized critical areas include open-based critical areas and short-based critical areas.

4. The method according to claim 1, wherein the respective pre-characterized critical areas include critical areas based on multiple random defect particle radii.

5. The method according to claim 1, further comprising:
determining respective defect densities of the one or more patterns based on respective pre-characterized defect densities of the one or more pre-characterized patterns,
wherein the defect limited yield of the layer is predicted based on the respective pre-characterized defect densities.

6. The method according to claim 5, wherein the respective pre-characterized defect densities include open-based defect densities and short-based defect densities based on multiple random defect particle radii.

7. The method according to claim 1, wherein the one or more patterns constitute a first area of the layer, the method further comprising:
determining a second area of the layer as a total area of the layer that excludes the one or more patterns; and
determining a critical area of the second area based on conventional critical area analysis,
wherein the defect limited yield is predicted based on the respective pre-characterized critical areas and the critical area of the second area.

8. The method according to claim 1, wherein the one or more pre-characterized patterns include an outer border area of empty space.

9. The method according to claim 8, wherein a width of the outer border area is based on a random defect particle radius to prevent a short based on a random defect particle interacting with a neighboring pattern.

10. An apparatus comprising:
at least one processor; and
at least one memory including computer program code for one or more programs, the at least one memory and the computer program code configured to, with the at least one processor, cause the apparatus to perform the following:
match one or more patterns within a layer of an integrated circuit design layout to one or more pre-characterized patterns within a pattern library;
determine respective critical areas of the one or more patterns based on respective pre-characterized critical areas of the one or more pre-characterized patterns; and
predict a defect limited yield of the layer based on the respective pre-characterized critical areas.

11. The apparatus according to claim 10, wherein the apparatus is further caused to:
determine numbers of repetitions of the one or more patterns in the layer,
wherein the defect limited yield of the layer is based on a weighting of the respective pre-characterized critical areas based on the numbers of repetitions.

12. The apparatus according to claim 10, wherein the respective pre-characterized critical areas include open-based critical areas and short-based critical areas.

13. The apparatus according to claim 10, wherein the respective pre-characterized critical areas include critical areas based on multiple random defect particle radii.

14. The apparatus according to claim 10, wherein the apparatus is further caused to:
determine respective defect densities of the one or more patterns based on respective pre-characterized defect densities of the one or more pre-characterized patterns,
wherein the defect limited yield of the layer is predicted based on the respective pre-characterized defect densities.

15. The apparatus according to claim 14, wherein the respective pre-characterized defect densities include open-based defect densities and short-based defect densities based on multiple random defect particle radii.

16. The apparatus according to claim 10, wherein the one or more patterns constitute a first area of the layer, and the apparatus is further caused to:
determine a second area of the layer as a total area of the layer that excludes the one or more patterns; and
determine a critical area of the second area based on conventional critical area analysis,
wherein the defect limited yield is predicted based on the respective pre-characterized critical areas and the critical area of the second area.

17. The apparatus according to claim 10, wherein the one or more pre-characterized patterns include an outer border area of empty space.

18. The apparatus according to claim 17, wherein a width of the outer border area is based on a random defect particle radius to prevent a short based on a random defect particle interacting with a neighboring pattern.

19. A method comprising:
building a pattern library of integrated circuit design layout library patterns pre-characterized based on critical area and defect density for multiple defect particle radii;
scanning an integrated circuit design layout to determine one or more patterns within one or more layers that match one or more library patterns within the pattern library;
determining respective critical areas and respective defect densities of the one or more patterns based on respective pre-characterized critical areas and respective pre-characterized defect densities of the matching one or more library patterns; and
predicting respective defect limited yields of the one or more layers based on the respective pre-characterized critical areas and the respective defect densities.

20. The method according to claim 19, further comprising:
prioritizing correction of the one or more patterns based on the respective defect densities.
